(19) United States
(12) Patent Application Publication
(10) Pub. No.: US 2011/0243250 A1
(43) Pub. Date: Oct. 6, 2011

(54) DEVICE AND METHOD FOR ENCODING/DECODING

(75) Inventors: Euee-Seon Jang, Seoul (KR); Sin-Wook Lee, Seoul (KR); Hyun-Gyu Kim, Seoul (KR); Hwa-Seon Shin, Seongnam-si (KR); Sang-Heon Lee, Suseong-gu (KR); Byeong-Ho Choi, Yongin-si (KR); Chung-Ku Lee, Bupyeong-gu (KR)

(73) Assignee: INDUSTRY-UNIVERSITY COOPERATION FOUNDATION HANYANG UNIVERSITY, Seoul (KR)

(21) Appl. No.: 13/083,460

(22) Filed: Apr. 8, 2011

Related U.S. Application Data
(63) Continuation of application No. PCT/KR2009/005818, filed on Oct. 12, 2009.

(30) Foreign Application Priority Data
Oct. 10, 2008 (KR) 10-2008-0099852

(51) Int. Cl. H04N 7/26

(52) U.S. Cl. 375/240.25; 375/E07.027

(57) ABSTRACT

An apparatus and a method for encoding/decoding video data are disclosed. In one embodiment, the decoding apparatus includes: i) a toolbox unit configured to store a plurality of functional units, ii) a separation unit configured to receive a decoder description and separate the decoder description into schema information and connection control information and output the schema information and the connection control information. The decoding apparatus may further include iii) a parser configured to parse and output input bitstream by using the schema information, iv) a decoder forming unit configured to load and connect pertinent functional units from the toolbox unit based on the connection control information and to form a reconfigured decoder; and v) a decoding solution configured to decode the bitstream outputted from the parser by using the reconfigured decoder. At least one embodiment can reconfigure a decoder in various form by using the decoder description.

### CROSS-REFERENCE TO RELATED APPLICATIONS

This application is a continuation application, and claims the benefit under 35 U.S.C. §§120 and 365 of PCT Application No. PCT/KR2009/005818, filed on Oct. 12, 2009, which is hereby incorporated by reference. PCT/KR2009/005818 also claimed priority from Korean Patent Application No. 10-2008-0099852, filed on Oct. 10, 2008, which is hereby incorporated by reference.

### BACKGROUND

1. Field

The described technology generally relates to encoding and decoding, more specifically to a device and a method for encoding and decoding video data through reconfiguration of functional units that perform unit decoding.

2. Description of the Related Technology

Moving pictures are commonly transcoded to a bitstream form by an encoder. The bitstream is stored according to an encoding type that satisfies the conditions of the encoder.

MPEG requires syntax and semantics for the conditions of a bitstream. Syntax refers to the structure or form and length of data, and indicates the order of expressing the data. In other words, syntax is for conforming to the grammar for encoding/decoding operations and defines the order of elements included in the bitstream as well as the length and form of each element.

Semantics indicates what each of the bits constituting the data means. That is, semantics shows the meaning of each element in the bitstream.

Therefore, various types of bitstreams can be generated according to the encoding conditions or applied standard (or codec) of the encoder. Generally, each standard (e.g., MPEG-1, MPEG-2, MPEG-4, MPEG-4 AVC, etc.) has different bitstream syntax.

Furthermore, every bitstream that is encoded according to a different standard or encoding condition has different forms (i.e., syntax and semantics), and it is required that a decoder corresponding to the encoder be used in order to decode the bitstream.

As described above, there has been a restriction in the general bitstream decoder to satisfy the conditions of the encoder, and this restriction has made it difficult to realize a unified decoder that could address multiple standards.

### SUMMARY

One inventive aspect is a method and an apparatus for decoding a bitstream that can decode a bitstream that is encoded in various forms (syntax, semantics) according to different standards (e.g., MPEG-1, MPEG-2, MPEG-4, MPEG-4 AVC, etc.).

Another aspect is a method and an apparatus for encoding/decoding that can use functional units for decoding by efficiently distinguishing and identifying the functional units.

Another aspect is a method and an apparatus for encoding/decoding that can use functional units for decoding by distinguishing, storing and readily identifying the functional units according to their types.

Another aspect is a method and an apparatus for encoding/decoding that can generate an extended bitstream, in which a decoder description is added, or generate a bitstream and the decoder description independently so that a bitstream that is encoded in various formats (syntax, semantics) based on each standard can be decoded by a same information recognition method.

Another aspect is a method and an apparatus for encoding/decoding in which bitstreams that are compressed in various encoding methods are parsed by a same information analysis method and the functional units for decoding are organically controlled by using the parsed data.

Another aspect is a method and an apparatus for encoding/decoding that can present scheduling management of each codec and an organic process structure (e.g., parallel combination structure, serial combination structure, independent process structure, individual process structure, etc.) of each functional unit by using a decoder description.

Another aspect is a method and an apparatus for encoding/decoding that can commonly apply a syntax analyzing method for decoding various forms of bitstreams.

Another aspect is a method and an apparatus for encoding/decoding that can apply a set of new commands for parsing various forms of bitstreams by a common syntax analyzing method.

Another aspect is a method and an apparatus for encoding/decoding in which a decoder can readily decode a bitstream even when a syntax element is changed, added or deleted.

Another aspect is a method and an apparatus for encoding/decoding in which element information (i.e., a result of syntax parsing) of analyzed syntax can be used by elements used for decoding a bitstream.

Another aspect is a method and an apparatus for encoding/decoding in which element information of pre-analyzed syntax can be used for analyzing a following bitstream syntax element.

Another aspect is a method and an apparatus for encoding/decoding in which functions included in various decoding processes suggested by different standards (codecs) are divided according to functional units and provided in a toolbox.

Another aspect is a method and an apparatus for encoding/decoding that can use necessary functional units selectively from the toolbox in order to decode bitstreams that are encoded in various forms.

Another aspect is a method and an apparatus for encoding/decoding that can readily change, add or delete functional units stored in the toolbox.

Another aspect is a method and an apparatus for accomplishing an international standard for integration of codecs for bitstream decoding, generation of decoder description for allowing a bitstream to be processed by a same information analysis method and realization of an extended bitstream.

Another aspect is a method and an apparatus for encoding/decoding that can be universally used in various encoding formats.

In one embodiment, the decoding apparatus includes: a toolbox unit configured to store a plurality of functional units; a separation unit configured to receive a decoder description and separate the decoder description into schema information and connection control information and output the schema information and the connection control information; a parser configured to parse and output input bitstream by using the schema information; a decoder forming unit configured to load and connect pertinent functional units from the toolbox unit based on the connection control information and to form a reconfigured decoder; and a decoding solution configured to decode the bitstream outputted from the parser by using the reconfigured decoder. The parser can use: a main function that is paged to drive the syntax parsing algorithm; a function that can be paged within the main function and is configured to read a length of bits corresponding to a variable indicating a bit length from an inputted bitstream and returning a value of the length of bits; and a function that can be paged within the main function and is configured to allow the parser to output an output including data indicating an output value and an identifier for identifying the kind of output value.

The parser can further use a function that can be paged within the main function and is configured to preview a length of bits corresponding to a variable indicating a bit length from an inputted bitstream and returning a value of the length of bits.

The parser can further use a function that can be paged within the main function and is configured to return an entire list of kinds of dath, which the current parser can output, in an arrangement format. The parser can use syntax parsing algorithm realized with ECMAScript.

The schema information can be related to details of syntax information included in the bitstream and can include at least one of a length of syntax information, a meaning of syntax information, an appearance condition of syntax information and the number of repeated appearances of syntax information.

The decoding method can include: a) receiving a decoder description and separating the decoder description into schema information and connection control information and outputting the schema information and the connection control information; b) parsing and outputting input bitstream by using the schema information; c) loading and connecting pertinent functional units from the toolbox unit based on the connection control information and forming a reconfigured decoder; and decoding the bitstream outputted from the parser by using the reconfigured decoder. The step b) can parse the input bitstream by using: a main function that is paged in order to drive the syntax parsing algorithm; a function that can be paged within the main function and is configured to read a length of bits corresponding to a variable indicating a bit length from an inputted bitstream and returning a value of the length of bits; and a function that can be paged within the main function and is configured to allow the parser to output an output including data indicating an output value and an identifier for identifying the kind of output value.

The step b) can parse the input bitstream by further using a function that can be paged within the main function and is configured to preview a length of bits corresponding to a variable indicating a bit length from an inputted bitstream and returning a value of the length of bits.

The step b) can parse the input bitstream by further using a function that can be paged within the main function and is configured to return an entire list of kinds of data, which the current parser can output, in an arrangement format.

The step b) can use syntax parsing algorithm realized with ECMAScript.

The schema information can be related to details of syntax information included in the bitstream and can include at least one of a length of syntax information, a meaning of syntax information, an appearance condition of syntax information and the number of repeated appearances of syntax information.

### BRIEF DESCRIPTION OF THE DRAWINGS

FIG. 1 is a diagram illustrating a brief structure of a typical decoder.

FIG. 2 is a diagram illustrating a brief structure of a typical encoder.

FIG. 3 is a block diagram of an encoder in accordance with an embodiment.

FIG. 4 is a block diagram of a decoder in accordance with an embodiment.

FIG. 5 is a detailed illustration of processing a bitstream by a decoding unit in accordance with an embodiment.

FIG. 6 illustrates a process of inputting a decoder description in accordance with another embodiment.

FIG. 7 is a block diagram of a decoder in accordance with an embodiment.

FIG. 8 is a block diagram of a decoding unit shown in FIG. 4 in accordance with an embodiment.

FIG. 9 illustrates a configuration of a BSDL parser in accordance with another embodiment.

FIG. 10 illustrates a detailed configuration of a toolbox in accordance with an embodiment.

FIG. 11 illustrates functional unit identification (FUID) in accordance with an embodiment.

FIG. 12 is a conceptual diagram for illustrating a functional unit distinguishing/identifying mechanism in accordance with an embodiment.

### DETAILED DESCRIPTION

Terms such as “first” and “second” can be used in describing various elements, but the above elements shall not be restricted to the above terms. The above terms are used only to distinguish one element from the other. For instance, the first element can be named the second element, and vice versa. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and are not considered limiting. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments will be described in detail with reference to the accompanying drawings. Identical or corresponding elements will be given the same reference numerals, regardless of the figure number, and any redundant description of the identical or corresponding elements may not be repeated.

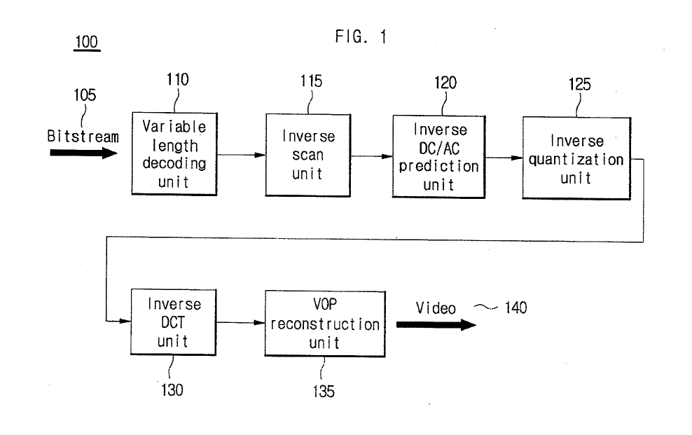

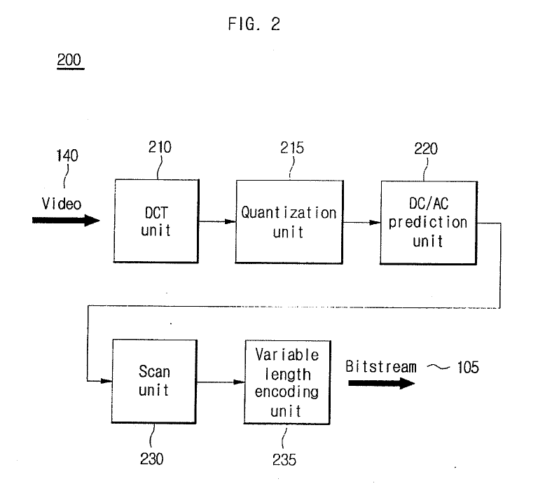

FIG. 1 is a diagram illustrating a brief structure of a typical decoder, and FIG. 2 is a diagram illustrating a brief structure of a typical encoder.

As illustrated in FIG. 1, a typical MPEG-4 decoder 100 includes a variable length decoding unit 110, an inverse scan unit 115, an inverse DC/AC prediction unit 120, an inverse quantization unit 125, an inverse DCT (discrete cosine transform) unit 130, and a VOP reconstruction unit 135. It shall be apparent that the structure of the decoder 100 can vary depending on the applied standard and that some element(s) can be substituted by other element(s).

Once a transferred bitstream 105 is syntax-parsed and header information and encoded video data are extracted, the variable length decoding unit 110 creates a quantized DCT coefficient by use of a predetermined Huffman table, and the inverse scan unit 115 performs an inverse scan to generate data in the same order of a moving picture 140. In other words, the inverse scan unit 115 outputs a value in an order that is inverse of the order used for scanning during the encoding. After quantization is performed during the encoding, the direction of scanning can be defined according to the distribution of frequency band values. A zig-zag scan method is commonly used, but the scan method can vary according to the codec.

Syntax parsing can be unifiedly performed in the variable length decoding unit 110 or in an element that processes the bitstream 105 prior to the variable length decoding unit 110. In such a case, since a same standard is applied to both the encoder and the decoder, the syntax parsing is processed in accordance with a predetermined criterion in order to conform to the corresponding standard.

The inverse DC/AC prediction unit 120 determines the orientation of a reference block for prediction in a frequency band by use of the size of the DCT coefficient.

The inverse quantization unit 125 inversely quantizes the inverse-scanned data. That is, DC and AC coefficients are restored by use of a quantization parameter (QP) assigned during the encoding.

The inverse DCT unit 130 performs an inverse discrete cosine transform to obtain an actual moving picture pixel value and generate a VOP (video object plane).

The VOP reconstruction unit 135 reconstructs and outputs a video signal by use of the VOP generated by the inverse DCT unit 130.

As shown in FIG. 2, an MPEG-4 encoder 200 typically includes a DCT unit 210, a quantization unit 215, a DC/AC prediction unit 220, a scan unit 230 and a variable length encoding unit 235.

As it is evident to those who are skilled in the art, each of the elements included in the encoder 200 performs an inverse function of its corresponding element of the decoder 100. In brief, the encoder 200 encodes a video signal (i.e., a digital image pixel value) by transforming the video signal to a frequency value through discrete cosine transform, quantization, etc., and then performs variable length encoding, which differentiates the bit length according to the frequency of data, to output the bitstream in a compressed state.

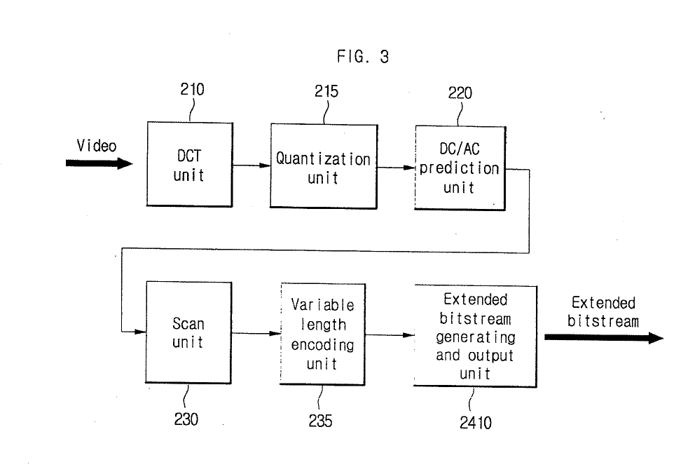

FIG. 3 is a block diagram of an encoder in accordance with an embodiment.

An encoder in accordance with an embodiment additionally includes an extended bitstream generation and output unit 2410, compared to the conventional decoder 200 described earlier with reference to FIG. 2. The extended bitstream generation and output unit 2410 generates a decoder description using control information (e.g., a list and connection relation of functional units used, input data of pertinent functional units, syntax information, syntax connection information, etc.) of a process of generating a conventional bitstream 316 that is generated by a process up to a preceding step. Moreover, an extended bitstream 305 is generated and transferred to a decoder 300 by using a generated decoder description 310 and the conventional bitstream 316.

The encoder has a tool box that includes a plurality of encoding functional units, and can generate a bitstream based on at least one encoding standard through a successive combination or an organic combination of the functional units included in the tool box.

Moreover, the variable length encoding unit 235 used in this description simply refers to any element (e.g., an encoding part) in an encoder that ultimately performs decoding in order to generate the conventional bitstream 316 and is not restricted to this.

In FIG. 3, it is assumed that the extended bitstream generated using decoder description information and conventional bitstream is provided to the decoder.

However, it is possible that the decoder description is transferred to the decoder 300 in the form of a separate data or bitstream. In this case, it shall be apparent that an encoded decoder description generation and output unit (not shown) is placed at a tail end of the variable length encoding unit 235 to provide an encoded decoder description that is generated independent of a conventional encoding unit to the decoder 300.

The decoder description includes functional unit identification (FUID) of pertinent functional units. The FUID is constituted by including a toolbox number (TBN) field, which indicates a toolbox to which the pertinent functional unit belongs in a toolbox unit, and an FU number field, which indicates proper identification information of the pertinent functional unit.

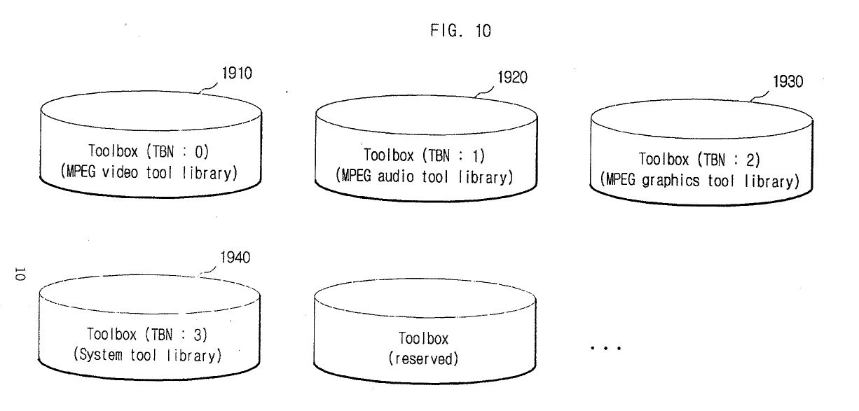

The FUID and toolbox unit will be described later with reference to the relevant drawings (FIG. 10 to FIG. 12) and relevant table (Table 5).

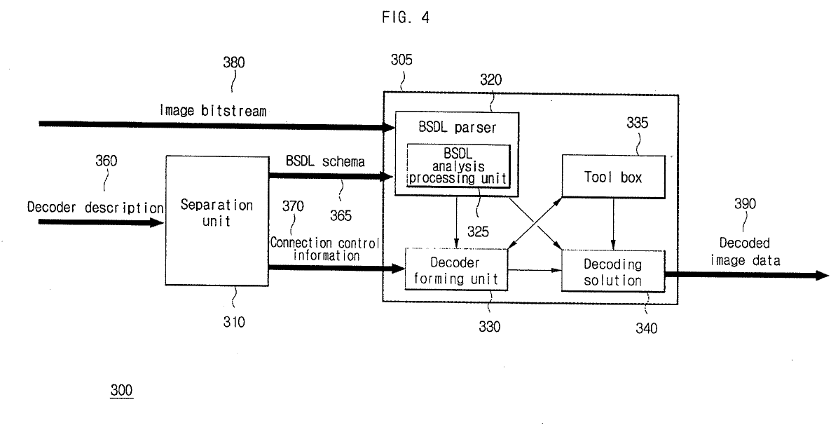

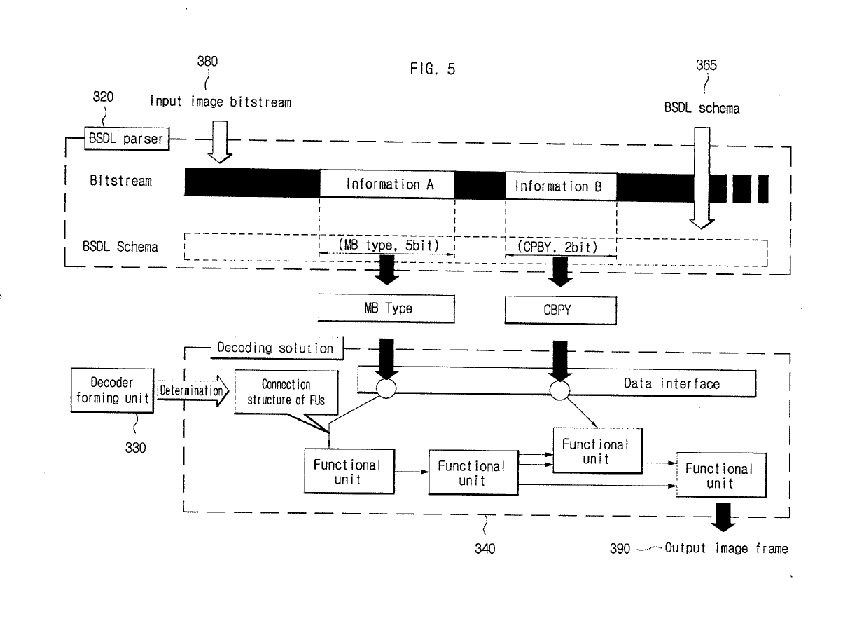

FIG. 4 is a block diagram of a decoder in accordance with an embodiment, and FIG. 5 is a detailed illustration of processing a bitstream by a decoding unit shown in FIG. 4.

A decoder description and an image bitstream shown in FIG. 4 can be, for example, information generated and provided by an encoder.

Referring to FIG. 4, the decoder 300 includes a decoding unit 305 and a separation unit 310. The decoding unit 305 includes a BSDL parser 320, a decoder forming unit 330, a tool box 335 and a decoding solution 340.

The BSDL parser 320 uses BSDL schema inputted from the separation unit 310 to analyze syntax information of the image bitstream inputted from the outside. The image bitstream inputted to the BSDL parser 320 is data encoded by an encoding method (e.g., MPEG-4, AVS, etc.). In this specification, it shall be appreciated by those who are skilled in the art that the BSDL parser 320 itself can analyze the BSDL schema or can be constituted by an outside algorithm.

The BSDL parser 320 includes a BSDL analysis processing part, which is an internal processing unit for redefining the structure of the BSCL parser 320 by reading the BSDL schema, which is described in XML.

As rules of redefining by use of the BSDL schema can vary depending on the method applied by a creator, the basic objects of redefining are as follows. Firstly, it is for recognizing information on the length and meaning of the bitstream written on the BSDL schema. Secondly, it is for reading a repetition structure and conditional execution structure that are defined on the BSDL schema and realizing a program-style routine that is actually operated by the same repetition or condition sentence. Therefore, the BSDL parser 320 prior to the redefining can be defined as a state in which functions for achieving the above objects are realized, and the redefining process can refer to a process of realizing the actually operating BSDL parser 320 by utilizing the above parsing functions.

The BSDL parser 320 is realized in a program that can constitute a fluid data flow by the control of the BSDL analysis processing part, and can be realized by use of program languages such as CAL (Caltrop Actor Language), C, C++ and Java.

A BSDL internal processing unit 2525 and the BSDL parser 320 can be realized without any restriction according to design criteria of a decoder designer. It shall be of course possible to apply a BSDL operating program such as BSDL reference software that is conventionally presented. The BSDL reference software is the official software created for a smooth operation of BSDL that is standardized by the MPEG standardizing organization, and it shall be apparent that the BSDL parser 320, which is inputted with BSDL schema, can be also readily realized by use of such software resource.

As mentioned in this specification, the structure of the BSDL parser 320—can be designed by a variety of methods chosen by the decoder designer. That is, the decoder designer can freely choose the application and design of detailed algorithm for performing the designated function of the BSDL parser 320. However, the BSDL parser 320 can be redefined by the result of reading the BSDL schema, and the result of redefining must cooperate (e.g., communicate) with other elements of the decoding unit 305.

The BSDL schema, with which the BSDL parser 320 is inputted, is described with details on syntax information included in the bitstream, and the details can include, for example, the length of the syntax information, the meaning of the syntax information, the appearance condition of the syntax information and the number of repeated appearances of the syntax information. Here, the length of the information refers to the bit length occupied by particular information, and the meaning of the syntax information refers to what the pertinent information means. For example, when a functional unit requests information called “A,” the meaning of the syntax information is needed to distinguish which information is the information referred by “A.” Moreover, with respect to the appearance condition or the number of repeated appearances, since appearance or the number or repetitions of some syntax information can be changed according to the attribute of the bitstream even when same size bitstreams are processed using one BSDL schema, the information can be attached to the BSDL schema in order to define such case. For example, the appearance condition can be needed to not read motion vector information when an intra frame is processed, and if a pertinent macro block has 6 blocks of the same structure, the number of repeated appearances can be used to repeat the pertinent block.

As illustrated in FIG. 5, the BSDL analysis processing unit transfers the result information of deciphering the details to the BSDL parser 320 in order to assist the BSDL parser 320 to read the information included in the bitstream according to the order defined in the BSDL schema.

The BSDL parser 320 refers to the result information provided by the BSDL analysis processing unit to covert the details of the inputted bitstream to meaningful data and provides the data to the decoder forming unit 330 and/or the decoding solution 340. Moreover, examples of meaningful data that the BSDL parser 320 provides to the decoder forming unit and/or the decoding solution 340 can include encoded image data in a predetermined macro block size, AC prediction flag (ACpred_flag) for intra-coded macro blocks, MCBPC (MB type & coded block pattern for chrominance) and CBPY (coded block pattern for luminance). The process of providing such data can be performed irrelevant to the operation of the decoder forming unit 330 or the decoding solution 340.

The present embodiment is for allowing the decoder description to be realized in a structure that uses a BSDL language system and its linkable XML-based format while the decoder decodes the bitstream by using the decoder description. Those who are skilled in the art shall readily understand that, in the present embodiment, the decoder description can have an XML format, such as BSDL and CALML, and that the role can be divided in such a way that the BSDL schema is used during the process of syntax parsing and the CALML is used for connection control between functional units.

The BSDL language is described in an XML document, which includes information on the structure and constituting method of bitstream, or in an XML schema form. This language is created to express a bitstream structure of one or more images. By using the BSDL language, the decoder can be highly compatible with other technologies even if the bitstream technology that is verified and used by the conventional MPEG standard is applied as it is. The language format and grammar about the BSDL are described in Part 5 of MPEG-B, and thus the detailed description will be omitted herefrom.

Described below is an example of constituting BSDL schema and connection control information using BSDL and XML. It shall be of course apparent that the constitution of BSDL schema and connection control information is not restricted to what is described below.

BSDL Schema

<xsd:element name=“VideoObject”>
<xsd:complexType>

<xsd:sequence>
<xsd:element name=“VOStartCode”

type=“m4v:StartCodeType”/>

<xsd:element name=“VOL”>

<xsd:complexType>

```
  <xsd:sequence>
  <xsd:element name=“header”
  type=“VOLHeaderType”
```

bs2:ifNext=“&volSC;”rvc:port=“0”/>

<xsd:element name=“VOP”

type=“VideoObjectPlaneType”
maxOccurs=“unbounded”
bs2:ifNext=“&vopSC;” rvc:port=“1”/>

</xsd:sequence>

</xsd:complexType>

</xsd:element>

</xsd:sequence>

</xsd:complexType>
</xsd:element>
Connection Control Information
<Network name=“Decoder”>
<Package>
<QID>
<ID id=“MPEG4 Simple Profile” />
</QID>
</Package>
<Port kind=“Input” name=“BITSTREAM” />
<Port kind=“Ouput” name=“YUV” />
<Instance id=“1”>
<Class name=“Parser”>
<QID>
<ID id=“c” />
</QID>
</Class>
<Note kind=“label” name=“Stream Parser” />
</Instance>
<Instance id=“2”>
<CIass name=“VS”>
<QID>
<ID id=“c” />
</QID>
<Note kind=“label” name=“Video Session” />
</Class>
</Instance>
Connection src=“” src-port=“BITSTREAM” dst=“1”

dst-port=“BITSTREAM” />

Connection src=“1” src-port=“CSCI” dst=“2” dst-port=“CSCI” />
Connection src=“1” src-port=“DATA” dst=“2” dst-port=“DATA” />
Connection src=“2” src-port=“YUV” dst=“” dst-port=“YUV” />
</Network>

In another embodiment, a decoder description is produced by a method of partially or entirely decoding an image bitstream with a script program based on ECMAScript.

The BSDL schema, which is a method of describing an image bitstream element according to the MPEG-B Part 5 standard, can also use a script program that is written in ECMAScript language as well as XML.

Below is an example of a method of paging a script program written in ECMAScript language in the BSDL schema.

<xsd:simpleType name=“macroblock”>

<xsd:restriction base=“bs1x:userType”>

<xsd:annotation><xsd:appinfo>

<bs1x:script ref=“macroblock.js”/>

</xsd:appinfo></xsd:annotation>

</xsd:restriction>

</xsd:simpleType>

Below is an example of a script program written in ECMAScript language that is paged in the above example.

function parserMain ( ) {

CSCI.CBP=new Array(6);
var MV_X, MV_Y, MV_rX, MV_rY;
var read_length;
var return_value;
//var temp;
var i;
if (CSCI.VOP_coding_type!=0) {

return_value=readBits(1);
if (return_value) {

// Not coded MB: Default CBP (all 0)
CSCI.MBtype=0;
for (i=0; i<6; i++) CSCI.CBP[i]=0;
return;

}

}
/*MCBPC (MBtype & CBPC)*/ {

if (CSCI.VOP_coding_type==0) {

return_value = HuffmanVLD(“B-6”);

} else {

rerurn_value = HuffmanVLD(“B-7”);

}
CSCI.MBtype = return_value[0];
CSCI.CBP[4]=return_value[1];
CSCI.CBP[5]=return_value[2];

}
if (CSCI.MBtype==3 || CSCI.MBtype==4) {

| | |
|---|---|
| readBits(1); | // AC pred. flag |

}
/*CBPY*/ {

if (CSCI.MBtype==3 || CSCI.MBtype==4) {

return_value=HuffmanVLD(“B-8”); // CBPY Intra
CSCI.CBP[0]=return_value[0] ? 1 : 0;
CSCI.CBP[1]=return_value[l] ? 1 : 0;
CSCI.CBP[2]=return_value[2] ? 1 : 0;
CSCI.CBP[3]=return_vaIue[3] ? 1 : 0;

} else {

return_value=HuffmanVLD(“B-8”); // CBPY Inter
CSCI.CBP[0]=return_value[0] ? 0 : 1;
CSCI.CBP[1]=return_value[l] ? 0 : 1;
CSCI.CBP[2]=return_value[2] ? 0 : 1;
CSCI.CBP[3]=return_value[3] ? 0 : 1;

}

}
if (CSCI.MBtype==1 || CSCI.MBtype==4) {

| | |
|---|---|
| readBits(2); | //DQuant |

}
if (! (CSCI.MBtype==3 || CSCI.MBtype==4 ||

CSCI.VOP_coding_type==0)) {

i=0; //R121
do {

// Motion Vector
read_length = CSCI.VOP_Fcode_foward-1;
MV_X = HuffmanVLD(“B-12”);
if (CSCI.VOP_Fcode_foward!=1 && MV_X!=0) {

MV_rX = readBits(read_length);

} else {

MV_rX = 0;

}
MV_Y = HuffmanVLD(“B-12”);
if (CSCI.VOP_Fcode_foward!=1 && MV_Y!=0) {

MV_rY = readBits(read_length);

} else {

MV_rY = 0;

}
token_output(“MV_X”, MV_X)
token_output(“MV_Y”, MV_Y);
token_output(“MV_rX”, MV_rX);
token_output(“MV_rY”, MV_rY);
i++;

} while (CSCI.MBtype==2 && i<4);//R121.b

}
// BLOCK
for (i=0; i<6; i++) {

B_MP4_SP (CSCI, i)

}

}

The language describing a script program like in the above examples conforms to a conventional language system defined in the ECMA 262 standard, and thus no detailed description thereof will be provided herein.

The conventional BSDL schema is on the premise that only one piece of syntax element information is decoded with one paging of the script program, and does not define a method of delivering the analyzed information to a functional unit through an interface, as shown in FIG. 5. Therefore, in the present embodiment, the following functions within the program are defined by a syntax parser in order to indicate a partial or entire syntax parsing process of a bitstream using ECMAScript.
parserMain( ) A first function (Entry point) that is paged first for driving a syntax parsing algorithm constructed with ECMAScript and that functions like “main( ) in, for example, the “C” language.
readBits(bit_length): A function that can be paged within the “parserMain( ) function and reads bits in the amount of “bit_length” from the inputted bitstream to return its value.
tokenOutput(token_name, token_data: A function that can be paged within the “parserMain( )” function and that allows the syntax parser to output an output having an output value identifier, named “token_name”, and a data value of “token_data”. The outputted data is later delivered to a data interface shown in FIG. 10.

Moreover, by additionally defining the following functions within the program, convenience is provided in designing a decoder description.
peekBits(bit_length): A function that can be paged within the “parserMain( )” function and that previews bits in the amount of “bit_length” from the inputted bitstream to return its value.
getToken( ) A function that can be paged within the “parserMain( )” function and that returns an entire list of the kinds of data, which the current syntax parser can output through the data interface, in an arrangement format.

It shall be appreciated that the BSDL parser that is inputted with the BSDL schema including the description of the syntax parsing process prepared with ECMAScript should be able to drive a script program based on ECMAScript, and it shall be appreciated that each of the above functions should be paged and processed in a method that fits the role of each function during the driving process of the script program.

In the above example, it was described that the ECMAScript is delivered as a part or entirety of the BSDL schema in accordance with a method defined by the BSDL standard. However, since the ECMAScript is a universal script language that is defined as a standard independently, it is possible for the ECMAScript to be included in a delivery medium other than the BSDL or to be transmitted independently. Moreover, the grammar for dialects of ECMAScript that is verified for their suitability to the ECMAScript standard (ECMA 262) can be used through a minor modification of the process of driving the script program of the syntax parser.

Although it is assumed in this embodiment that information such as decoder description 2560 and encoded video data 2580 is inputted from the outside, it shall be apparent that at least one of the information is already included in an element of the decoding unit 305.

Referring to FIG. 4 again, the decoder forming unit 330 controls to realize the decoding solution 340 by using the connection control information received from the separation unit 310 and/or some of the bitstream data received from the BSDL parser 320 (for example, encoded image data in a predetermined macro block size, AC prediction flag (ACpred_flag) for intra-coded macro blocks, MCBPC (MB type & coded block pattern for chrominance) and CBPY (coded block pattern for luminance)).

That is, the decoder forming unit 330 uses the connection control information, etc. to control some or all of the functional units provided in the tool box 335 to be loaded and arranged in an organic relation in the decoding solution 240. Here, the connection control information can be written in CALML (CAL Markup Language), which is an XML format for describing a decoder constitution in CAL language (Caltrop Markup Language) that is currently discussed in the MPEG standardizing organization. The CAL language is constituted with Actors, which are program objects, and a connection relation between the Actors, and this structure of the CAL language is expressed by an XML format. An example of the expression has been already presented earlier in relation to the expression of the BSDL schema and connection control information.

Specifically, the decoder forming unit 330 is authorized to access the tool box 335, which is constituted by a number of functional units, and configures input/output connections between functional units in the tool box 335 to constitute the resulting decoding solution 340. Here, the input/output connection structure and executing order between the functional units are configured by referring to the connection control information. Moreover, it is possible that some information is transferred from the BSDL parser 320 in order to distinguish the kinds of the inputted bitstream and the transferred information can be referred during the process of connecting the functional units. Once the connection structure between the functional units is determined, the connection structure can be regarded as an independent decoder that can analyze and decode all kinds of bitstreams intended by the creator of the pertinent decoder description, assuming that data is continuously inputted from the outside. This completed connection structure of the functional units can be named as the decoding solution 340.

The tool box 335 includes a plurality of functional units, which are embodied to carry out a respective predetermined process. Each of the functional units can be also embodied as a combination of program codes.

The functional units included in the tool box 335 can be further grouped into a plurality of tool boxes according to their functions. For example, the functional units for MPEG can be grouped in a first tool box, and the functional units for functions other than MPEG can be grouped in a second tool box. Alternatively, the functional units for MPEG-2 can be grouped in the first tool box, and the functional units for MPEG-4 can be grouped in the second tool box, while the functional units for AVS, which is the digital TV compression standard in China, can be grouped in a third tool box.

Of course, the tool box 335 itself can be embodied in a plurality to have independent relations with the decoder forming unit 330 and the decoding solution 340. In this case, although not illustrated, the first tool box, the second tool box, etc. can be embodied as independent tool boxes.

However, for the convenience of description, it will be assumed here that a plurality of tool boxes are included in one tool box 335 or all functional units are scattered in one tool box 335.

The tool box 335 is an area in which the functional units (FU) for carrying out their respective functions are included, and the functional units are loaded to the decoding solution by the connection control of the decoder forming unit 330 to form a successive connection operation relation and outputs encoded image data included in an image bitstream 380 as decoded image data.

Examples of functional units included in the tool box 335 can include a DF (De-blocking Filter) FU, a VR (VOP Reconstructor) FU, an FFR (Frame Field Reordering) FU, an IPR (Intra prediction and Picture Reconstruction) FU, an IT (Inverse Transform) FU, an IQ (Inverse Quantization) FU, an TAP (Inverse AC Prediction) FU, an IS (Inverse Scan) FU and a DCR (DC Reconstruction) FU.

For an IT4×4 FU, an IQ4×4 FU and a DCR4×4 FU, the size of a block being processed is 4×4. This is because MPEG-4 AVC processes the data in the block size of 4×4 while, in the case of MPEG-1/2/4, the data in the block size of 8×8 is processed during the transform, quantization and prediction.

It shall be apparent that all functional units for carrying out a data decoding function can be included in the tool box 335 regardless of the standard applied to the functional unit and any necessary functional units developed during the advancement of technology can be added to the tool box 335. It shall be also apparent that existing functional units can be modified and any unnecessary functional unit may be deleted. For example, in case an IS4×4 functional unit and the like that process the data in the block size of 4×4 is additionally needed for a decoding process, the pertinent functional units can be added to the tool box 335. Also, an SPR (Special Prediction) functional unit and the like can be added for carrying out an intra prediction in MPEG-4 AVC.

It shall be apparent that each functional unit provided in the tool box 335 is not independently present in each standard and that the functional units capable of the same process regardless of the standard can be combined in one functional unit. The function of each functional unit is well known to those of ordinary skill in the art, and thus will be briefly described herein.

The DF functional unit is the de-blocking filter of MPEG-4 AVC, and the VR FU is the functional unit that stores a restored pixel value.

The FFR FU is the functional unit for the interlaced mode, and the IPR FU is the functional unit that stores a restored pixel value after intra prediction of MPEG-4 AVC. As described above, the intra prediction of MPEG-4 AVC can be carried out by the SPR FU.

The IT FU is the functional unit that carries out inverse transform of DC and AC values, and the IQ FU is the functional unit that carries out inverse quantization of AC values.

The LAP FU is the functional unit that carries out inverse AC prediction of AC values, and the IS FU is the functional unit that inverse scans AC values. The DCR FU is the functional unit that carries out inverse prediction and inverse quantization of DC values.

The decoding solution 340 is a result generated by the decoder forming unit 330 and is inputted with bitstream data divided into syntax information units (or encoded video data in predetermined macro block size) from the BSDL parser 320.

As illustrated in FIG. 5, the inputted bitstream data can be inputted through a tangible or intangible data interface for inputting/outputting data. In the case of software, the data interface can be embodied as a particular memory buffer, a virtual port that defines the flow of data, or a parameter on a program. In the case of hardware, the data interface can be a connection line on a circuit. The data interface can be embodied in various other ways.

The data can be continuously inputted through a pertinent interface and regardless of the particular functional unit's carrying out of a process (for example, so as to be capable of parallel process). The decoding solution 340 processes the inputted data and outputs the processed data as decoded image data. As illustrated in FIG. 5, the data can be started from a data interface and transferred to each functional unit, and the functional unit can process the pertinent data and transfer the data to a following functional unit. This flow of data is predetermined by the decoder forming unit 330.

Included in the decoding solution 340 can be data provided by the BSDL parser 320 (e.g., information extracted by syntax parsing of bitstream) and a storage unit for storing result data by the process of each functional unit. Each functional unit loaded by the control of the decoder forming unit 330 can carry out an assigned process by using at least one of data provided by the BSDL parser 320 and result data of a priorly operated functional unit. In this case, the functional unit to carry out a following process needs to recognize that the operation of the preceding functional unit is completed. For this, the decoder forming unit 330 can continuously monitor whether each functional unit has completed its operation and control whether a following functional unit should start its operation. Moreover, by providing a separate area for each functional unit in the storage area and allowing process result data of a preceding functional unit to be stored in a storage area for a following functional unit by the control of the decoder forming unit 330, it will be possible for the following functional unit to start its operation immediately after the data required for carrying out the process is stored in its storage area. It shall be apparent that there can be other various ways to control the starting time between the functional units.

The storage unit can be provided in the decoder forming unit 330, and the decoder forming unit 330 can provide the data provided by the BSDL parser 320 (e.g., information extracted by syntax parsing of bitstream) and the result data by the process of each functional unit to a functional unit that will carry out the current process.

Hereinafter, the operation of the decoding unit 305 will be briefly described with reference to FIG. 5.

Once an input image bitstream and BSDL schema are inputted from the outside (that is, information A and information B are assumed to be present at particular points of the bitstream), the BSDL parser 320 reads the BSDL schema and recognizes that 5 bits of MB type data are present at a point corresponding to the information A and 2 bits of CBPY data are present at a point corresponding to the information B.

Then, the BSDL parser 320 uses the recognized information to read the bits at each point according to the number of assigned bits, and transfers the read information to the decoding solution 340 according to its given meaning.

The decoding solution 340 receives from the BSDL parser 320 and processes data named MP Type and CBPY. As described earlier, the functional units are loaded and embodied in the decoding solution 340 by the connection control of the decoder forming unit 330.

The data interface that is present in the decoding solution 340 receives data transferred from the outside and, by referring to the connection relation between the functional units formed by the connection control information, transfers the data to the functional units that request the pertinent data.

Each functional unit carries out the decoding process in accordance with the predetermined connection relation (that is, connection relation for processing the data). Every data flow and connection relation between functional units is based on what the decoder forming unit 330 has priorly constituted. An output image frame is outputted to the outside by successive processes of the functional units.

As described above, the storage unit can be provided in the decoder forming unit 330 and/or the decoding solution 340. This is because the data can be provided by the BSDL parser 320 without intermission and in parallel with the decoding process. Moreover, each functional unit can read and use necessary data from the storage unit.

Moreover, the BSDL parser 320 can provide data for decoding the encoded image data to the decoder forming unit 330 and have the decoder forming unit 330 provide the data to the decoding solution 340, or the BSDL parser 340 itself can provide the data to the decoding solution 340.

Referring to FIG. 4 again, the separation unit 310 separates the inputted decoder description 2560 into separate information and inputs the separated information to the decoding unit 305. The decoder description 2560 inputted to the separation unit 310 can include BSDL schema 2565 for describing the structure of bitstream and CALML data 2570 for describing the decoding process of bitstream. The two kinds of data can be described independently according to XML grammar, or can be combined and transmitted together for an efficient decoder operation.

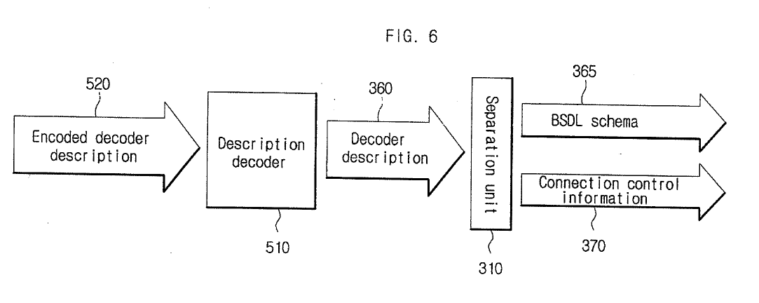

FIG. 6 shows a process of inputting a decoder description in accordance with another embodiment.

As illustrated in FIG. 6, the decoder 300 can additionally include a description decoder 510. The description decoder 510 can generate the decoder description 2560 by decoding an encoded decoder description 520 that is inputted and provide the decoder description 2560 to the separation unit 310.

By encoding and transmitting/receiving the decoder description 2560, the amount of data being transmitted/received can be reduced.

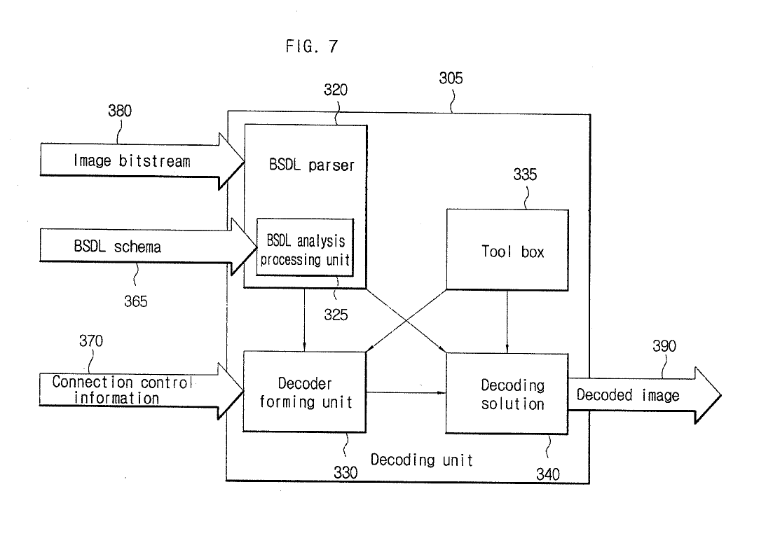

FIG. 7 is a block diagram of the decoder in accordance with another embodiment

It has been described already with reference to FIG. 4 that the decoder description 2560 and the image bitstream are inputted to the decoding unit 305, and with reference to FIG. 6 that the encoded decoder description 520 and the image bitstream 380 are inputted to the decoding unit 305.

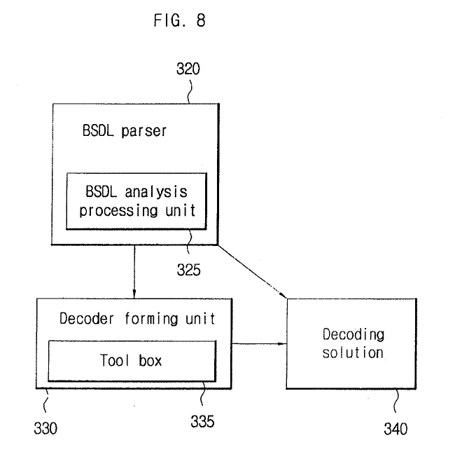

However, as illustrated in FIG. 7, it shall be apparent that the constitution information of the decoder description 2560 can be primitively separated and inputted to the decoding unit 305. In this case, it shall be apparent that the earlier-described separation unit 310 and decoder description 2560 can be omitted. FIG. 8 shows the constitution of a decoding unit in accordance with another embodiment.

The decoding unit 305 that is embodied by separating the tool box 335 and decoder forming unit 330 has been described already with reference to FIGS. 4 to 7.

However, as illustrated in FIG. 8, it shall be apparent that the tool box 335 can be embodied by being included as an element of the decoder forming unit 330.

In this case, the decoder forming unit 330 can include not only a function of controlling the connection structure between the functional units but also a function of selecting a functional unit to be used, and through this, various types of decoding solution 340 can be embodied.

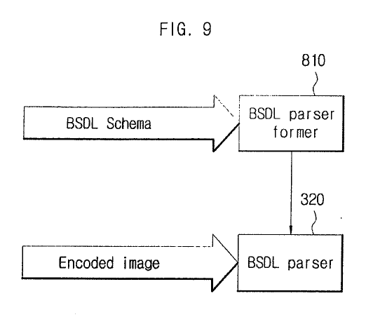

FIG. 9 illustrates a configuration of a BSDL parser in accordance with another embodiment.

The BSDL parser 320 that includes the BSDL analysis processing unit has been described earlier with reference to FIG. 4.

However, the BSDL parser 320 in accordance with an embodiment can be predefined and provided from the outside of the decoder 300 before the start of decoding a bitstream. Therefore, the earlier-described BSDL analysis processing unit can be omitted. Here, a BSDL parser former 2610 can be constituted by using a conventional application program, such as BSDL reference software.

Hitherto, the BSDL parser as an independent element processing a designated operation has been described. The BSDL parser can be embodied as a functional unit included in the tool box or can be embodied to be already included as an independent element in the decoding solution. In case the BSDL parser is provided in the tool box, the decoder forming unit should load and control the BSDL parser to carry out its process by using the connection control information before the functional units that operate for bitstream decoding are operated. Similarly, in case the BSDL parser is already included in the decoding solution, the decoder forming unit should control the BSDL parser to carry out its process first before the loaded functional units start to carry out their processes. In either case, the operation and function of the BSDL parser are same as the earlier description with reference to relevant drawings, and detailed description thereof will be omitted herefrom. However, it should be noted that the subject that initially receive the BSDL schema and/or bitstream needs to be changed to the decoder forming unit and/or decoding solution.

Hitherto, a decoding apparatus and a syntax analysis method for bitstream decoding in accordance with the an embodiment have been described with respect to MPEG-4 AVC, but it shall be apparent that the decoding apparatus and the syntax analysis method can be equivalently applied without any restriction to MPEG-1, MPEG-2, MPEG-4, AVS and other video encoding/decoding standards.

Moreover, it shall be apparent that the information included in the connection control information is described not only as information on a connection relation between functional units and on a process required for the pertinent functional unit for carrying out the decoding by one standard but also as information for carrying out the decoding based on a plurality of standards.

For example, in case it is assumed that the first several frames of an image bitstream are encoded in MPEG2, the following several frames in MPEG-4, and the remaining frames in MPEG-1, it shall be apparent that the connection control information is defined for decoding of the encoded image data in such a way that the functional units, which are included in the tool box 335 based on their respective standards, of the differently-encoded frames can be organically combined and operated.

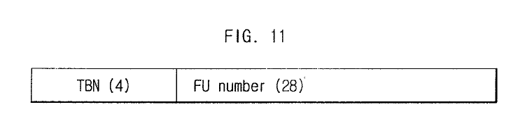

Hereinafter, yet another embodiment will be described with reference to relevant drawings. However, in describing yet another embodiment, any element that carries out an identical or very similar function to the previously-described embodiment will be rendered the same name and reference numeral, and description of such element will not be redundantly provided. For example, the tool box 335, decoder forming unit 330 and decoding solution 340 illustrated in FIG. 11 are fundamentally identical to the earlier-described elements.

FIG. 10 illustrates a detailed configuration of a toolbox in accordance with an embodiment.

As illustrated in FIG. 10, the toolbox can be constituted with a set of plural toolboxes that are separately grouped in order to store/manage a plurality of functional units according to their types. Hereinafter, the set of plural toolboxes will be referred to as a toolbox unit. That is, the functional units are stored/managed by being grouped in a number of toolboxes within the toolbox unit according to their types, and each of the toolboxes is distinguished, identified and managed with its toolbox number (TBN). In other words, the TBN is a kind of identification information.

Specifically, the toolbox unit can be constituted with functional units related to multimedia decoding, for example, an MPEG video toolbox that stores functional units related to MPEG video decoding, an MPEG audio toolbox that stores functional units related to MPEG audio decoding, an MPEG graphics toolbox that stores functional units related to MPEG graphic decoding and a system toolbox that stores functional units related to system decoding, and the toolbox unit can be constituted by including the plurality of toolboxes.

The TBN of the toolbox can be defined as shown in Table I below.

TABLE 1

| Tool Box Number, TBN | Tool-library |
|---|---|
| 0 | MPEG video tool library |
| 1 | MPEG audio tool library |
| 2 | MPEG graphics tool library |
| 3 | System tool library |
| 4 | Reserved |
| . . . | . . . |
| n | Reserved |

The toolbox unit and toolboxes can be logically distinguished and realized in one storage means or physically distinguished and realized in a plurality of storage means.

FIG. 11 illustrates functional unit identification (FUID) in accordance with an embodiment.

As illustrated in FIG. 11, the FUID in accordance with an embodiment is constituted by including a toolbox number (TBN) field, which indicates the toolbox to which the pertinent functional unit belongs, and an FU number field, which indicates proper identification information of the pertinent functional unit.

The TBN field can be realized with 4 bits, and the FU number field can be realized with 28 bits. By realizing the FU number field with 28 bits, 268,435,456 functional units can be stored, identified and used in one toolbox.

The FUID can be expressed by being included in a decoder description through, for example, a method of applying in the FUID field in the above-described VNT. Moreover, it shall be appreciated that the FUID can be also used in XML-based connection control information, which includes information having the same meaning, to designate each functional unit that is used for constituting a decoder.

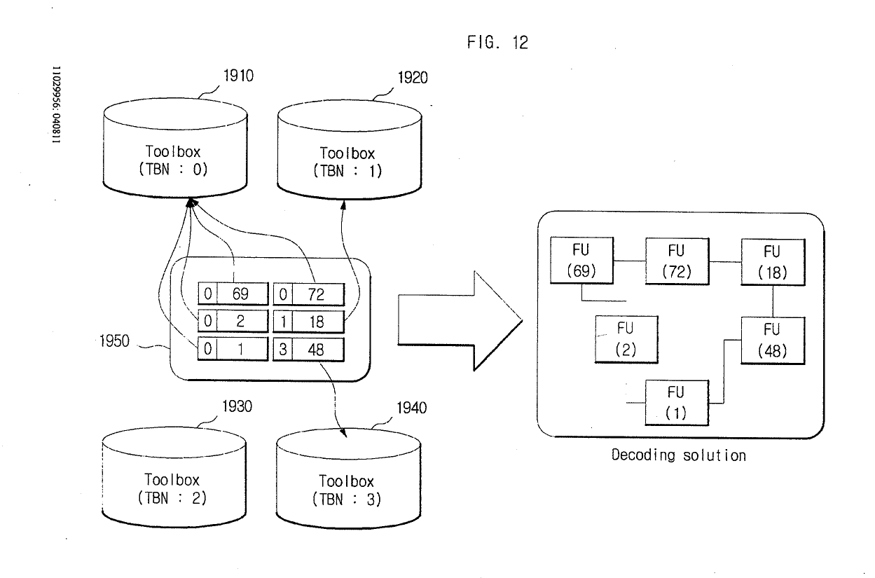

FIG. 12 is a conceptual diagram for illustrating a functional unit distinguishing/identifying mechanism in accordance with an embodiment.

Referring to FIG. 12, a decoder description analyzing unit or the BSDL parser of the decoding unit extracts FUID 1950 by analyzing the received decoder description, and the decoder forming unit reads the TBN and FU numbers of the functional units needed for configuring the decoder from the FUID 1950, and once the functional units corresponding to the read TBN and FU numbers are requested to the pertinent toolbox, the requested functional units are loaded and connected in the decoding solution, thereby forming a reconfigured decoder and decoding the inputted data.

For example, since the first FUID has the TBN of “0” and the FU number of “69,” a functional unit of which the FU number is “69” is requested and loaded among the functional units stored in the MPEG video toolbox 1910 in the toolbox. At least one of the disclosed embodiments can decode a bitstream that is encoded in various forms (syntax, semantics) according to different standards (e.g., MPEG-1, MPEG-2, MPEG-4, MPEG-4 AVC, etc.).

At least one of the disclosed embodiments can reconfigure a decoder by efficiently distinguishing and identifying functional units for decoding.

At least one of the disclosed embodiments can use functional units for decoding by distinguishing, storing and readily identifying functional units in a plurality of toolboxes according to their types.

At least one of the disclosed embodiments can generate an extended bitstream, in which a decoder description is added, so that a bitstream that is encoded in various formats (syntax, semantics) based on each standard can be decoded by a same information recognition method.

At least one of the disclosed embodiments can present scheduling management of each codec and an organic process structure (e.g., parallel combination structure, serial combination structure, independent process structure, individual process structure, etc.) of each functional unit by using a decoder description.

At least one of the disclosed embodiments can also allow design and construction of various systems with the described decoder description only.

At least one of the disclosed embodiments can also parse bitstreams that are compressed in various encoding methods by a same information analysis method and organically control the functional units for decoding by using the parsed data.

At least one of the disclosed embodiments can commonly apply a syntax analyzing method for decoding various forms of bitstreams.

At least one of the disclosed embodiments can also apply a set of new commands for parsing various forms of bitstreams by a common syntax analyzing method.

At least one of the disclosed embodiments can allow a decoder to readily decode a bitstream even when a syntax element is changed or deleted.

At least one of the disclosed embodiments also allows element information (i.e., a result of syntax parsing) of analyzed syntax to be used by elements used for decoding a bitstream.

At least one of the disclosed embodiments also allows element information of pre-analyzed syntax to be used for analyzing a following bitstream syntax element.

At least one of the disclosed embodiments can be used when combining codecs for moving pictures and still pictures that process in block units, other than MPEG-1, MPEG-2, MPEG-4 and MPEG-4 AVC.

At least one of the disclosed embodiments can divide functions included in various decoding processes suggested by different standards (codecs) according to functional units and store the functions in a toolbox.

At least one of the disclosed embodiments can use necessary functional units selectively from the toolbox in order to decode bitstreams that are encoded in various forms.

At least one of the disclosed embodiments can readily change, add or delete functional units stored in the toolbox.

Although some embodiments have been described above, it shall be appreciated that there can be a variety of permutations and modifications by those who are skilled in the art without departing from the technical ideas and scope of the claims appended below.

What is claimed is:

1. A decoding apparatus, comprising:
a toolbox unit configured to store a plurality of functional units;
a separation unit configured to receive a decoder description and separate the decoder description into schema information and connection control information and output the schema information and the connection control information;
a parser configured to parse and output input bitstream by using the schema information;
a decoder forming unit configured to load and connect pertinent functional units from the toolbox unit based on the connection control information and to form a reconfigured decoder; and
a decoding solution configured to decode the bitstream outputted from the parser by using the reconfigured decoder,
wherein the parser is configured to use:
a main function that is paged to drive the syntax parsing algorithm;
a function that can be paged within the main function and is configured to read a length of bits corresponding to a variable indicating a bit length from an inputted bitstream and returning a value of the length of bits; and
a function that can be paged within the main function and is configured to allow the parser to output an output including data indicating an output value and an identifier for identifying the kind of output value.

2. The apparatus of claim 1, wherein the parser is further configured to use a function that can be paged within the main function and is configured to preview a length of bits corresponding to a variable indicating a bit length from an inputted bitstream and returning a value of the length of bits.

3. The apparatus of claim 2, wherein the parser is further configured to use a function that can be paged within the main function and is configured to return an entire list of kinds of data, which the current parser can output, in an arrangement format.

4. The apparatus of claim 1, wherein the parser is further configured to use syntax parsing algorithm realized with ECMAScript.

5. The apparatus of claim 1, wherein the schema information is related to details of syntax information included in the bitstream and includes at least one of a length of syntax information, a meaning of syntax information, an appearance condition of syntax information and the number of repeated appearances of syntax information.

6. The apparatus of claim 1, wherein the toolbox unit comprises at least one of:
an MPEG video toolbox configured to store functional units related to MPEG video decoding;
an MPEG audio toolbox configured to store functional units related to MPEG audio decoding;
an MPEG graphics toolbox configured to store functional units related to MPEG graphic decoding; and
a system toolbox configured to store functional units related to system decoding.

7. A method of decoding data, comprising:
receiving a decoder description and separating the decoder description into schema information and connection control information and outputting the schema information and the connection control information;
parsing and outputting input bitstream by using the schema information;
loading and connecting pertinent functional units from the toolbox unit based on the connection control information and forming a reconfigured decoder; and
decoding the bitstream outputted from the parser by using the reconfigured decoder,
wherein the parsing comprises using:
a main function that is paged in order to drive the syntax parsing algorithm;
a function that can be paged within the main function and is configured to read a length of bits corresponding to a variable indicating a bit length from an inputted bitstream and returning a value of the length of bits; and
a function that can be paged within the main function and is configured to allow the parser to output an output including data indicating an output value and an identifier for identifying the kind of output value.

8. The method of claim 7, wherein the parsing comprises using a function that can be paged within the main function and is configured to preview a length of bits corresponding to a variable indicating a bit length from an inputted bitstream and returning a value of the length of bits.

9. The method of claim 8 wherein the parsing comprises using a function that can be paged within the main function and is configured to return an entire list of kinds of data, which the current parser can output, in an arrangement format.

10. The method of claim 7, wherein the parsing comprises using syntax parsing algorithm realized with ECMAScript.

11. The method of claim 7, wherein the schema information is related to details of syntax information included in the bitstream and includes at least one of a length of syntax information, a meaning of syntax information, an appearance condition of syntax information and the number of repeated appearances of syntax information.

12. The method of claim 7, wherein the toolbox unit comprises at least one of:
an MPEG video toolbox configured to store functional units related to MPEG video decoding;
an MPEG audio toolbox configured to store functional units related to MPEG audio decoding;
an MPEG graphics toolbox configured to store functional units related to MPEG graphic decoding; and
a system toolbox configured to store functional units related to system decoding.

13. A decoding apparatus, comprising:
means for receiving a decoder description and separating the decoder description into schema information and connection control information and outputting the schema information and the connection control information;
means for parsing and outputting input bitstream by using the schema information;
means for loading and connecting pertinent functional units from the toolbox unit based on the connection control information and forming a reconfigured decoder; and
means for decoding the bitstream outputted from the parser by using the reconfigured decoder,
wherein the parsing means comprises means for using:
a main function that is paged in order to drive the syntax parsing algorithm;
a function that can be paged within the main function and is configured to read a length of bits corresponding to a variable indicating a bit length from an inputted bitstream and returning a value of the length of bits; and
a function that can be paged within the main function and is configured to allow the parser to output an output including data indicating an output value and an identifier for identifying the kind of output value.
